(19) United States
(12) Patent Application Publication
(10) Pub. No.: US 2012/0306945 A1
(43) Pub. Date: Dec. 6, 2012

(54) IMAGE SIGNAL PROCESSING DEVICE FOR SEQUENTIALLY DRIVING A PLURALITY OF LIGHT SOURCES, DISPLAY APPARATUS USING THE IMAGE SIGNAL PROCESSING DEVICE, AND DISPLAY METHOD THEREOF

(75) Inventors: Ho-seop LEE, Seongnam-si (KR); Dae-sik KIM, Hwaseong-si (KR); Jong-hoon JUNG, Suwon-si (KR); Young-ji KO, Seoul (KR); Seong-phil CHO, Seoul (KR)

(73) Assignee: SAMSUNG ELECTRONICS CO., LTD., Suwon-si (KR)

(21) Appl. No.: 13/486,721

(22) Filed: Jun. 1, 2012

(30) Foreign Application Priority Data
Jun. 1, 2011 (KR) 10-2011-0052816

(51) Int. Cl. G09G 5/10

(52) U.S. Cl. 345/691

(57) ABSTRACT

An image signal processing device, a display apparatus, and a display method are provided. The image signal processing device includes: a light source driver which turns on a plurality of light sources providing different colors, in a given order; a sub-frame calculator which divides a frame of an input image signal into a plurality of sub-frames; a display processor which sequentially outputs the plurality of sub-frames on a display panel; and a sync signal processor which outputs a sync signal to the backlight driver to turn on the plurality of light sources in each of the plurality of sub-frames, in the given order.

### CROSS-REFERENCE TO RELATED APPLICATION

This application claims priority from Korean Patent Application No. 10-2011-0052816, filed on Jun. 1, 2011, in the Korean Intellectual Property Office, the disclosure of which is incorporated herein by reference in its entirety.

### BACKGROUND

1. Field

Apparatuses and methods consistent with exemplary embodiments relate to image signal processing, and more particularly, to image signal processing which sequentially drives a plurality of light sources providing different colors.

2. Description of the Related Art

With the development of technology, a display apparatus, such as a television (TV), has been rapidly developed. In particular, a cathode-ray tube (CRT) type display apparatus has been replaced with a flat panel type display apparatus which is thinner and lighter than the CRT type display apparatus.

Examples of such a flat panel type display apparatus include a plasma display panel (PDP) display apparatus, a liquid crystal display (LCD) apparatus, etc. Currently, the LCD apparatuses are more widely used than other types of display apparatuses.

An LCD apparatus includes a liquid crystal panel and a backlight unit. Here, the liquid crystal panel includes a plurality of liquid crystal cells which are arranged in a matrix and a plurality of switches which switches video signals respectively supplied to the liquid crystal cells. Besides a lamp, a light-emitting diode (LED) is recently used as a light source of the backlight unit.

The backlight unit uses a frame sequential color (FSC) method to provide light at higher efficiency in order to obtain a higher image quality. The FSC method is also referred to as a field sequential color method.

The FSC method means a driving method by which a plurality of light sources are sequentially driven to produce an afterimage in human eyes so that humans recognize a color, in order to display a color. According to the FSC method, a color may be realized without using red (R), green (G), and blue (B) color filters.

However, if the FSC method is used, pixel light emission positions do not agree with one another on an eye moving path of a user, i.e., a vision trace of the user, and a screen. Therefore, a color breakup phenomenon occurs.

Accordingly, a technique addressing this problem is needed.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiment provide an image signal processing device which appropriately drives light sources of a backlight unit to reduce a color breakup phenomenon, a display apparatus using the image processing device, and a display method thereof

According to an aspect of an exemplary embodiment, there is provided an image signal processing device. The image signal processing device may include: a light source driver which turns on a plurality of light sources providing different colors, in a given order; a sub-frame calculator which divides a frame of an input image signal into a plurality of sub-frames; a display processor which sequentially outputs the plurality of sub-frames on a display panel; and a sync signal processor which outputs a sync signal to the backlight driver to turn on the plurality of light sources in each of the plurality of sub-frames, in the given order.

The display processor may include: a divider which divides the input image signal into a plurality of color components; and a data selector which selectively provides data of the input image signal to the display panel according to the plurality of sub-frames divided by the sub-frame calculator.

If the sub-frame calculator divides the frame into “n” sub-frames where “n” is an integer greater than or equal to 2, the sync signal processor increases a frequency of an output vertical sync signal by “n” times a frequency of an input vertical sync signal and reduces a number of output horizontal sync signals to “1/n” times a number of input horizontal sync signals.

The sub-frame calculator may divide the frame of the input image signal into an odd line sub-frame indicating odd lines of the frame and an even line sub-frame indicating even lines of the frame.

The plurality of light sources may include red (R), green (G), and blue (B) light sources.

If the R, G, and B light sources are sequentially turned on in one sub-frame, the display processor may display black on the display panel before displaying a next sub-frame.

The image signal processing device may further include a compensator which performs a frame compensation with respect to each of the plurality of sub-frames.

According to an aspect of another exemplary embodiment, there is provided a display apparatus. The display apparatus may include: a light unit which includes a plurality of light sources providing different colors; a light source driver which turns on the plurality of light sources of the light unit in a given order; a display unit which outputs an image according to an input image signal; a processor which divides a frame of the input image signal into a plurality of sub-frames, provides the plurality of sub-frames to the display unit to sequentially output the plurality of sub-frames, and outputs a sync signal to the light source driver to turn on the plurality of light sources in each of the plurality of sub-frames in the given order; and a controller which controls the light source driver, the processor, and the display unit.

The processor may include: a sub-frame calculator which divides the frame of the input image signal into “n” frames, where “n” is an integer greater than or equal to 2; a display processor which sequentially outputs the “n” sub-frames on a display panel; and a sync signal processor which adjusts an output vertical sync signal and an output horizontal sync signal according to a number of the sub-frames and outputs the adjusted output vertical and horizontal sync signals to the light source driver.

The display processor may include: a divider which divides the input image signal into a plurality of color components; and a data selector which selectively provides data of the input image signal to the display unit according to the plurality of sub-frames divided by the sub-frame calculator.

The sync signal processor may increase a frequency of the output vertical sync signal by “n” times a frequency of an input vertical sync signal and reduces a number of output horizontal sync signals to “1/n” times a number of input horizontal sync signals.

The processor may include: a sub-frame calculator which divides the frame of the input image signal into an odd line sub-frame indicating odd lines of the frame and an even line sub-frame indicating even lines of the frame; a display processor which sequentially outputs the odd line sub-frame and the even line sub-frame on a display panel; and a sync signal processor which adjusts an output vertical sync signal and an output horizontal sync signal and outputs the adjusted output vertical and horizontal sync signals to the light unit so as to turn on the plurality of light sources in the odd line sub-frame in the given order and turn on the plurality of light sources in the even line sub-frame in the given order.

The plurality of light sources may include R, G, and B light sources. If the R, G, and B light sources are sequentially turned on in one sub-frame, the display processor may display black on the display unit before displaying a next sub-frame.

The display apparatus may further include a compensator which performs a frame compensation with respect to each of the plurality of sub-frames.

According to an aspect of another exemplary embodiment, there is provided a display method. The display method may include: dividing a frame of an input image signal into a plurality of sub-frames; adjusting an input vertical sync signal and an input horizontal sync signal according to a number of the sub-frames to generate an output vertical sync signal and an output horizontal sync signal; and sequentially outputting the plurality of sub-frames and turning on a plurality of light sources of a light unit providing different colors in each of the sub-frames in a given order, according to the output vertical sync signal and the output horizontal sync signal.

If the frame of the input image signal is divided into “n” sub-frames, where “n” is an integer greater than or equal to 2, a frequency of the output vertical sync signal is increased by “n” times a frequency of an input vertical sync signal, and a number of output horizontal sync signals is reduced to “1/n” times a number of input horizontal sync signals.

The display method may further include: if the plurality of light sources comprise R, G, and B light sources, and the R, G, and B light sources are sequentially turned on in one sub-frame, displaying black before displaying a next sub-frame.

The display method may further include performing a frame compensation with respect to each of the plurality of sub-frames.

As described above, according to the exemplary embodiments, a color breakup phenomenon may be reduced in a frame sequential color (FSC) driving method without additional hardware.

Additional aspects and advantages of the exemplary embodiments will be set forth in the detailed description, will be obvious from the detailed description, or may be learned by practicing the exemplary embodiments.

### BRIEF DESCRIPTION OF DRAWINGS

The above and/or other aspects will be more apparent by describing in detail exemplary embodiments, with reference to the accompanying drawings, in which:

FIG. 1 is a block diagram illustrating a structure of an image signal processing device according to an exemplary embodiment;

FIG. 2 is a block diagram illustrating a structure of an image signal processing device according to another exemplary embodiment;

FIG. 3 is a view illustrating a method of reducing a color breakup phenomenon by using an image signal processing method according to an exemplary embodiment;

FIG. 4 is a view illustrating a display driving state which is synchronized with backlight driving;

FIG. 5 is a block diagram illustrating a structure of a display apparatus according to an exemplary embodiment;

FIG. 6 is a block diagram illustrating a structure of a display apparatus according to another exemplary embodiment; and

FIG. 7 is a flowchart illustrating a display method according to an exemplary embodiment; and

FIG. 8 is a flowchart illustrating a method of driving red (R), green (G), and blue (B) light sources in a display method, according to an exemplary embodiment.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

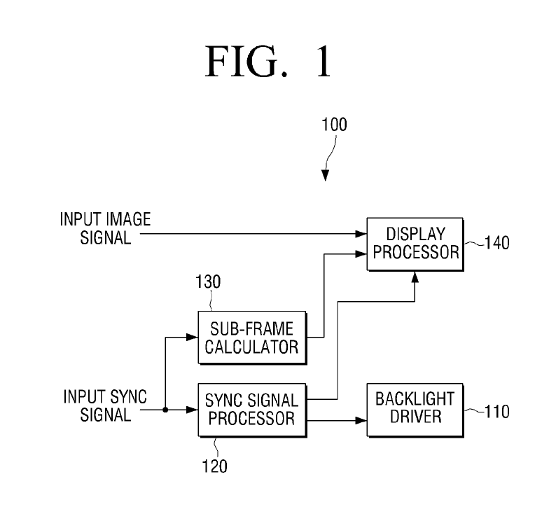

FIG. 1 is a block diagram illustrating a structure of an image signal processing device according to an exemplary embodiment. The image signal processing device 100 of FIG. 1 may be realized in a device such as a media player, a TV or the like which processes an image signal. For example, the image signal processing device 100 may be realized as a module or chip which is installed in the device and processes the image signal.

Referring to FIG. 1, the image signal processing device 100 includes a backlight driver 110, a sync signal processor 120, a sub-frame calculator 130, and a display processor 140.

The backlight driver 110 sequentially turns on a plurality of light sources which provide different colors and are installed in a backlight unit. In more detail, the backlight driver 110 outputs a driving signal which is to turn on the plurality of light sources in each color in a predetermined order, for example, in a sequential order, according to display diming.

The sub-frame calculator 130 divides a frame of an input image signal into a plurality of sub-frames. For example, the sub-frame calculator 130 may toggle a vertical sync signal of an input sync signal to divide each of frames of the input image signal into an odd line sub-frame and an even line sub-frame. Here, the odd line sub-frame indicates a sub-frame which includes only odd lines of all lines of a corresponding frame, and the even line sub-frame indicates a sub-frame which includes only even lines of the corresponding frame.

The number of sub-frames divided by the sub-frame calculator 130 may be three or more. In other words, the sub-frame calculator 130 may divide each frame into “n” sub-frames (where “n” is an integer greater than or equal to 2). For example, the sub-frame calculator 130 may divide each frame into three sub-frames, i.e., first through third sub-frames. Here, the first sub-frame includes first, fourth, seventh, . . . , and m^{th} lines, a second sub-frame includes second, fifth, eighth, . . . , and (m+1)^{th} lines, and a third sub-frame includes third, sixth, ninth, . . . , and (m+2)^{th} lines. Alternatively, the sub-frame calculator 130 may generate sub-frames in a different pattern from the above sub-frame pattern in the different number from the above number of sub-frames.

The display processor 140 sequentially processes the sub-frames divided by the sub-frame calculator 130 so that each sub-frame can be displayed on a display panel.

The sync signal processor 120 outputs the sync signal to the backlight driver 110 so that the plurality of light sources are turned on in each of the sub-frames sequentially once. As a result, an operation of sequentially turning on the plurality of light sources is performed in each of the sub-frames, and thus, is performed a plurality of number of times in one frame. Therefore, although a display state of an object is changed according to a vision trace, a color breakup phenomenon may be reduced.

The sync signal processor 120 adjusts a state of the sync signal, which is to drive the plurality of light sources, based on the number of sub-frames, so that the plurality of light sources are driven in each of the sub-frames sequentially once.

For example, if one frame is divided into an odd line sub-frame and an even line sub-frame as described above, and the plurality of light sources include red (R), green (G), and blue (B) light sources, the sync signal processor 120 may adjust an output sync signal, so that the R, G, and B light sources are sequentially turned on when the odd line sub-frame is displayed on a display panel, and then, are sequentially re-turned on when the even line sub-frame is displayed on the display panel.

In other words, if one frame is divided into “n” sub-frames, the sync signal processor 120 may increase a frequency of an output vertical sync signal by “n” times a frequency of an input vertical sync signal, and reduce the number of output horizontal sync signals to “1/n” times an input horizontal sync signal. For example, if one frame is divided into four sub-frames, the sync signal processor 120 adjusts a frequency of an output vertical sync signal four times fast so that each of the R, G, and B light sources is turned on four times when one frame is displayed and reduces the number of output horizontal sync signals to 1/4 times.

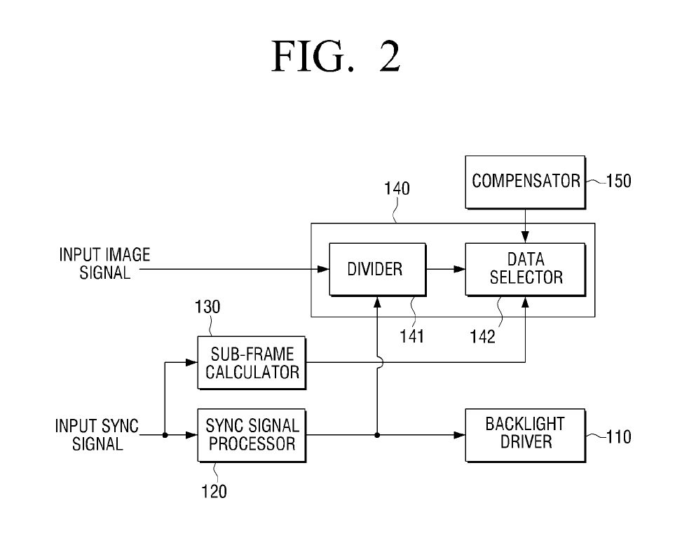

FIG. 2 is a block diagram illustrating a structure of an image signal processing device 100 according to another exemplary embodiment. Referring to FIG. 2, the image signal processing device 100 includes a backlight driver 110, a sync signal processor 120, a sub-frame calculator 130, a display processor 140, and a compensator 150. The display processor 140 includes a divider 141 and a data selector 142.

Operations of the backlight driver 110, the sync signal processor 120, and the sub-frame calculator 130 of FIG. 2 are the same as those of the backlight driver 110, the sync signal processor 120, and the sub-frame calculator 130 of FIG. 1, and thus, their repeated descriptions will be omitted.

The divider 141 of the display processor 140 divides an input image signal into a plurality of color components. In more detail, the divider 141 may divide R, G, and B channels from the input image signal according to a sync signal of an output frame. In other words, the divider 141 converts each frame of the input image signal into R, G, and B channels using a color space conversion method. The R, G, and B channels may individually realize R, G, and B fields or may be combined with one another to form cyan (C), magenta (M), yellow (Y), and white (W) fields.

The data selector 142 selectively provides data of the input image signal to a display panel according to a plurality of sub-frames divided by the sub-frame calculator 130.

In other words, the data selector 142 provides color channels, which are divided by the divider 141, to the display panel in preset sequential orders. The display panel controls liquid crystal cells to display an image, based on input scan signals and data signals under control of a controller (not shown) which is separately installed.

The backlight driver 110 sequentially turns on a plurality of light sources according to an output sync signal adjusted by the sync signal processor 120 as described above, so that the plurality of light sources are turned on once when each of the sub-frames is displayed on the display panel

The compensator 150 indicates a part which compensates an output image. In more detail, the compensator 150 compensates a display point of an image object of each of the sub-frames using a motion estimation method and/or a motion compensation method. In other words, the compensator 150 detects a pixel or a pixel group which is matched between a plurality of consecutive frames. Therefore, the compensator 150 estimates a motion vector of an image object corresponding to the detected pixel or pixel group. Also, the compensator 150 compensates a display point of the image object according to a size and a direction of the motion vector, and generates an interpolation frame having the image object of the compensated position. If a motion estimation and/or a motion compensation are applied with the addition of the compensator 150 as described above, a color breakup phenomenon may be further effectively reduced.

According to another exemplary embodiment, the compensator 150 may be omitted. Also, relations among elements of FIGS. 1 and 2 may be changed, and some elements (not shown) may be further added or omitted. In addition, it has been described in the above-described exemplary embodiments that color division is achieved through R, G, and B channels or C, M, Y, and W channels, but the present inventive concept is not limited thereto. Channels of additional primary colors or compound colors may be further used to extend a color representation area.

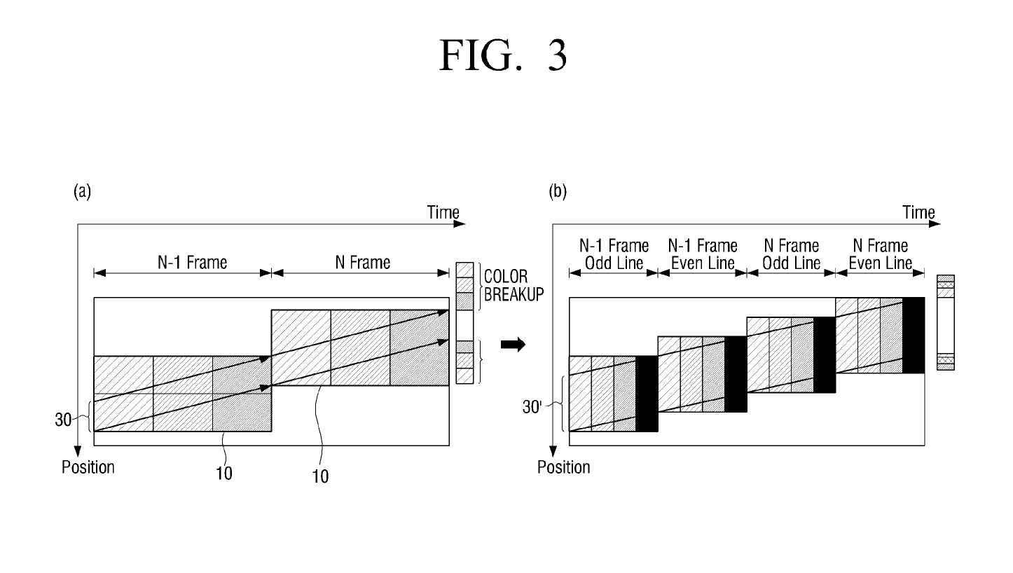

FIG. 3 illustrates graphs for an effect of preventing a color breakup phenomenon according to exemplary embodiments.

FIG. 3 illustrates a driving method (a) performed in a general apparatus which sequentially turns on R, G, and B light sources in each one frame. In FIG. 3, a horizontal axis indicates a time, and a vertical axis indicates a pixel position on a screen. As shown in (a) of FIG. 3, if a position of object 10 in an (N−1)^{th} frame is moved in an N^{th} frame, a vision trace of a user moves as indicated by arrows. In this case, R, G, and B color components are all included in an area 30 which overlaps along the vision trace between the (N−1)^{th} frame and the N^{th} frame. Therefore, the colors are normally generated for display. However, if at least one of the R, G, and B color components is not included in other areas which do not overlap with each other, a color breakup phenomenon occurs.

Also, FIG. 3 illustrates a method (b) of driving a backlight in an image signal processing device which divides one frame into an odd line sub-frame and an even line sub-frame, and turns on R, G, and B light sources, according to an exemplary embodiment. As shown in (b) of FIG. 3, the R, G, and B light sources are sequentially turned on in one of the two sub-frames. Next, the R, G, and B light sources are turned off, or amounts of lights of the R, G, and B light sources may be reduced to fixed values, until a next sub-frame starts. Therefore, if the next sub-frame is an even line sub-frame, colors may not be generated on the odd lines.

As described above, if one frame is divided into two sub-frames and displayed, a size of an area 30′, which overlaps along a vision trace, is increased. Specifically, as shown in (b) of FIG. 3, the size of the overlapped area 30′ across a vision trace between four sub-frames (i.e., the odd line sub-frame of the (N−1)^{th} frame, and the even line sub-frame of the (N−1)^{th} frame, the odd line sub-frame of the N^{th} frame, and the even line sub-frame of the N^{th} frame) is increased. Therefore, a part in which a color breakup occurs is reduced, thereby reducing a color breakup phenomenon recognized by a user.

In (b) of FIG. 3, one frame is divided into two sub-frames but may be divided into three or more sub-frames.

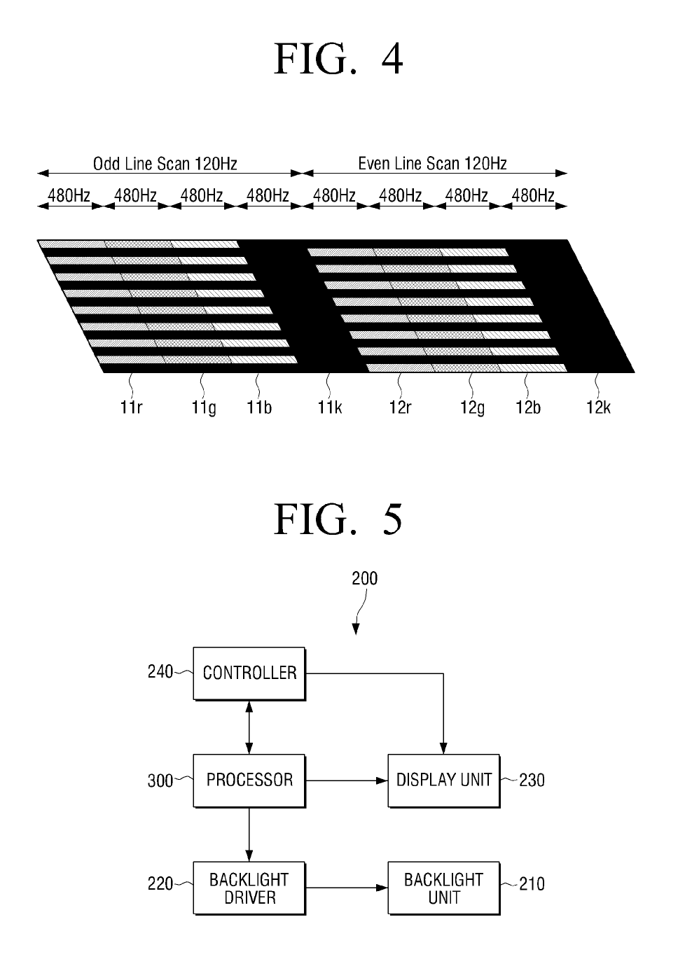

FIG. 4 is a view illustrating a method of displaying color data on a display panel according to an exemplary embodiment.

Referring to FIG. 4, if the display panel operates at a frequency of 240 Hz, an odd line sub-frame and an even line sub-frame are respectively displayed according to a horizontal sync signal of 120 Hz rate and a vertical sync signal of 480 Hz rate.

In this case, one sub-frame is divided into four sections. Also, R color data 11r is displayed in the first section, G color data 11g is displayed in the second section, and B color data 11b is displayed in the third section. Black 11k is displayed in the fourth section. Therefore, the one sub-frame does not affect a color line displayed in a next sub-frame. In other words, R color data 12r that is a first section of a next even line sub-frame may be normally displayed. Even in the even line sub-frame, G color data 12g and B color data 12b are sequentially displayed after the R color data 12r for the even lines, and then black 12k is displayed. This display may be referred to as a Pseudo 480 Hz driving method. The Pseudo 480 Hz driving method and a motion estimation and/or a motion compensation of 120 Hz may be performed together to prevent a color breakup phenomenon to prevent an image quality from being deteriorated. When black is displayed on the display panel as shown in (b) of FIG. 3, a backlight unit may turn off all of R, G, and B light sources or reduce amounts of lights of the R, G, and B light sources to fixed levels or less in a corresponding area.

FIG. 5 is a block diagram illustrating a structure of a display apparatus 200 according to an exemplary embodiment. Referring to FIG. 5, the display apparatus 200 includes a backlight unit 210, a backlight driver 220, a display unit 230, a controller 240, and a processor 300. The display apparatus 200 of FIG. 5 may be realized as various types of devices such as a TV, a monitor, an electronic frame, a cellular phone, a personal digital assistant (PDA), an MP3, etc.

The backlight unit 210 includes a plurality of light sources providing different colors. For example, the backlight unit 210 includes R, G, and B light sources. These light sources may be realized as light-emitting diodes (LEDs), cool cathode fluorescent lamps (CCFLs), or the like. A plurality of light sources may be provided with respect to each color. If the display apparatus 200 is a direct type display apparatus, the light sources are disposed on front surface of the backlight unit 210. If the display apparatus 200 is an edge type display apparatus, the light sources are disposed at an edge part. The light sources are turned on/off according to a driving signal input from the backlight driver 220.

The display unit 230 includes a display panel, a gate driving electrode, a data electrode, etc. to display data processed by the processor 300. A plurality of liquid crystal cells are arranged in a matrix on the display panel. A data line and a gate line are connected to each of the liquid crystal cells, and a thin film transistor (TFT) is formed at an intersection between the data line and the gate line.

The controller 240 applies a signal to the gate driving electrode and the data electrode according to the data processed by the processor 300 to switch the TFT. Therefore, the controller 240 may control the liquid crystal cells to be turned on or off

The processor 300 divides a frame of an input image signal into a plurality of sub-frames and provides the plurality of sub-frames to the display unit 230 to sequentially output the plurality of sub-frames. The processor 300 also outputs a sync signal to the backlight driver 220 to sequentially turn on a plurality of light sources in each of the sub-frames. The processor 300 of FIG. 5 may be a single chip or module.

The backlight driver 220 sequentially drives and turns on the plurality of light sources, which is installed in the backlight unit 210, according to the sync signal provided by the processor 300.

The controller 240 controls operations of the backlight driver 220, the processor 300, and the display unit 230 to achieve a display in a frame sequential color (FSC) driving method.

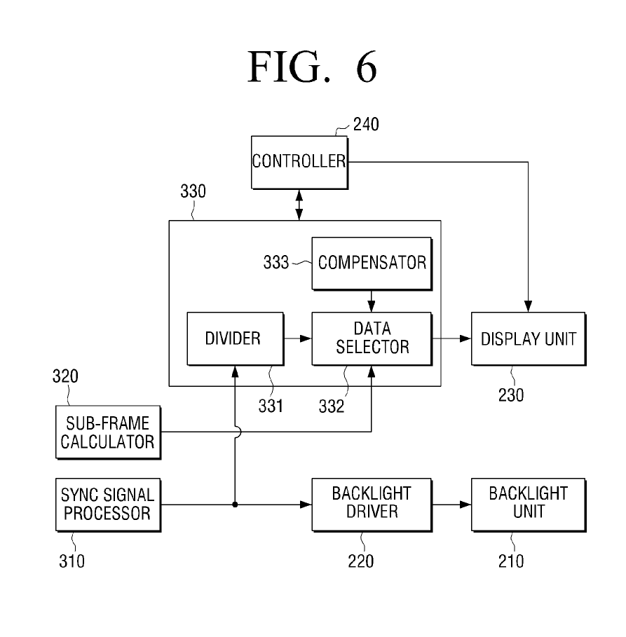

FIG. 6 is a block diagram illustrating a configuration of a display apparatus according to another exemplary embodiment.

Referring to FIG. 6, the display apparatus includes a backlight unit 210, a backlight driver 220, a display unit 230, a controller 240, a sync signal processor 310, a sub-frame calculator 320, and a display processor 330.

Here, the sub-frame calculator 320 is a structure which divides a frame of an input image signal into “n” sub-frames (where “n” is an integer greater than or equal to 2) as described with reference to FIGS. 1 and 2. Here, if “n” is 2, the frame of the input image signal may be divided into an odd line sub-frame and an even line sub-frame.

The sync signal processor 310 adjusts an output vertical sync signal and an output horizontal sync signal according to the number of sub-frames and outputs the adjusted output vertical and horizontal sync signals to the backlight driver 220.

The display processor 330 sequentially outputs the “n” sub-frames on a display panel.

If one frame is divided into “n” sub-frames, the sync signal processor 310 increases a frequency of the output vertical sync signal by “n” times a frequency of an input vertical sync signal and reduces the number of output horizontal sync signals to “1/n” times the number of input horizontal sync signals.

The sync signal adjusted by the sync signal processor 310 is provided to the display processor 330 and the backlight driver 220.

Referring to FIG. 6, the display processor 330 includes a divider 331, a data selector 332, and a compensator 333. The divider 331 divides the input image signal into a plurality of color components. The data selector 332 selectively provides data of the input image signal to the display unit 230 according to the plurality of sub-frames divided by the sub-frame calculator 320.

The divider 331 divides a plurality of color channels from the input image signal according to the sync signal provided from the sync signal processor 310.

The data selector 332 provides the color channels, which are divided by the divider 331, to the display unit 230 in preset sequential orders.

As described above, the compensator 333 compensates a display position of an image object in each of the sub-frames using a motion estimation method and/or a motion compensation method.

The compensator 333 is installed in the display processor 330 in FIG. 6 but may be installed as an additional module outside the display processor 330.

If “n” is set to 2, the sub-frame calculator 320 may divide the frame of the input image signal into an odd line sub-frame indicating odd lines of all lines of the frame and an even line sub-frame indicating even lines.

Accordingly, the display processor 330 sequentially displays the odd line sub-frame and the even line sub-frame. Also, the sync signal processor 310 outputs the sync signal to sequentially turn on the plurality of light sources in each of the sub-frames, with respect to the odd and even line sub-frames.

If the backlight unit 210 includes R, G, and B light sources, the backlight driver 220 outputs driving signals for the R, G, and B light sources to sequentially turn on the R, G, and B light sources in one sub-frame and to sequentially re-turn on the R, G, and B light sources when a next sub-frame starts, according to the sync signal. If each color component is displayed in one sub-frame, the data selector 332 controls the display unit 230 to display black before a next sub-frame is displayed.

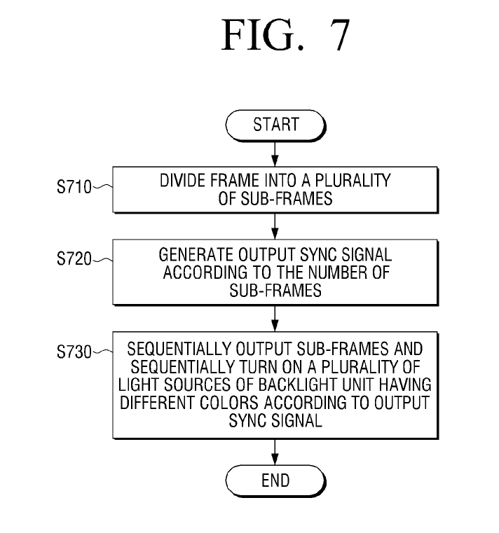

FIG. 7 is a flowchart illustrating a display method according to an exemplary embodiment. Referring to FIG. 7, in operation S710, a frame is divided into a plurality of sub-frames. In operation S720, an output sync signal is generated according to the number of sub-frames. The output sync signal includes an output vertical sync signal and an output horizontal sync signal.

In operation S730, the sub-frames are sequentially displayed on a display panel, and light sources of a backlight unit providing different colors are sequentially turned on according to the output sync signal. In other words, color light sources are turned on respectively once in one sub-frame. As a result, color light sources are turned on a plurality of number of times in one frame. Therefore, although an object moves along a vision trace, a color breakup phenomenon may be greatly reduced.

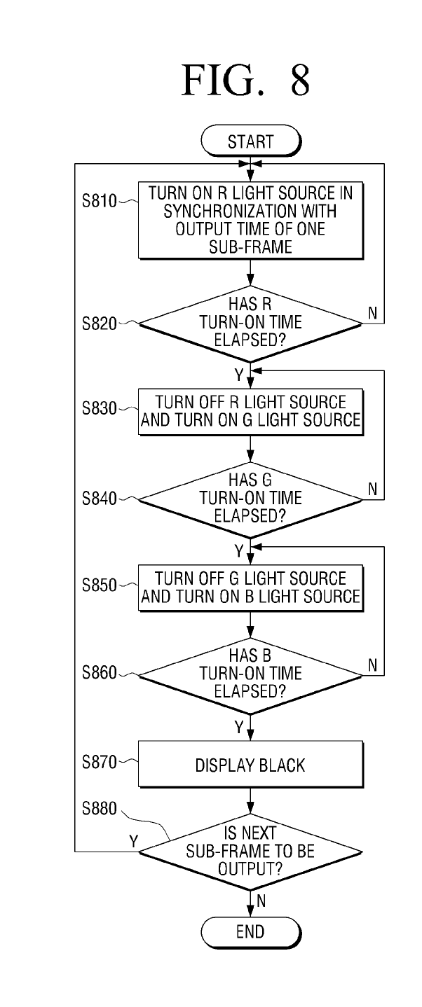

FIG. 8 is a flowchart illustrating an operation of driving light sources in a display method, according to an exemplary embodiment.

Referring to FIG. 8, in operation 810, an R light source is turned on in synchronization with an output time of one sub-frame. The turn-on state of the R light source is maintained for a given R turn-on time. In operation S820, a determination is made as to whether the R turn-on time has elapsed. If it is determined in operation S820 that the R turn-on time has elapsed, the R light source is turned off, and a G light source is turned on in operation S830. In operation S840, a determination is made as to whether a preset G turn-on time has elapsed. If it is determined in operation S840 that the preset G turn-on time has elapsed, the G light source is turned off, and a B light source is turned on in operation S850. In operation S860, a determination is made as to whether a B turn-on time has elapsed. If it is determined in operation S860 that the B turn-on time has elapsed, black is displayed for a preset time in operation S870. Here, the preset time to display black may be a remaining time in one sub-frame.

In operation S880, a determination is made as to whether a next sub-frame is to be output. If it is determined in operation S880 that the next sub-frame is to be output, the process returns to operation S810 to sequentially re-turn on the R, G, and B light sources.

As described above, R, G, and G light sources are used. However, types of light sources may be variously changed, and the number of light sources may also be variously determined as described above. Also, turn-on orders are not limited to orders of R, G, and B and may be variously changed.

As described above, according to various exemplary embodiments of the present inventive concept, one frame is divided into a plurality of sub-frames to perform frame (or field) sequential color (FSC) driving. Therefore, a color breakup phenomenon caused by a movement of an object may be effectively prevented.

An image signal processing method or a display method according to the above-described exemplary embodiments may be realized by a program code which can be stored in various types of recording media to be executed by a central processing unit (CPU) installed in various types of electronic devices.

In more detail, a code for performing the above-described methods may be stored in various types of recording media which can be read by a terminal, like a random access memory (RAM), a flash memory, a read only memory (ROM), an erasable programmable ROM (EPROM), an electronically erasable and programmable ROM (EEPROM), a register, a hard disk, a removable disk, a memory card, a universal serial bus (USB) memory, a CD-ROM, or the like.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image signal processing device comprising:
a light source driver which turns on a plurality of light sources providing different colors, in a given order;
a sub-frame calculator which divides a frame of an input image signal into a plurality of sub-frames;
a display processor which sequentially outputs the plurality of sub-frames on a display panel; and
a sync signal processor which outputs a sync signal to the backlight driver to turn on the plurality of light sources in each of the plurality of sub-frames, in the given order.

2. The image signal processing device as claimed in claim 1, wherein the display processor comprises:
a divider which divides the input image signal into a plurality of color components; and
a data selector which selectively provides data of the input image signal to the display panel according to the plurality of sub-frames divided by the sub-frame calculator.

3. The image signal processing device as claimed in claim 2, wherein if the sub-frame calculator divides the frame into “n” sub-frames, where “n” is an integer greater than or equal to 2, the sync signal processor increases a frequency of an output vertical sync signal by “n” times a frequency of an input vertical sync signal and reduces a number of output horizontal sync signals to “1/n” times a number of input horizontal sync signals.

4. The image signal processing device as claimed in claim 1, wherein the sub-frame calculator divides the frame of the input image signal into an odd line sub-frame indicating odd lines of the frame and an even line sub-frame indicating even lines of the frame.

5. The image signal processing device as claimed in claim 4, wherein the plurality of light sources comprise red (R), green (G), and blue (B) light sources, and
wherein if the R, G, and B light sources are sequentially turned on in one sub-frame, the display processor displays black on the display panel before displaying a next sub-frame.

6. The image signal processing device as claimed in claim 1, further comprising a compensator which performs a frame compensation with respect to each of the plurality of sub-frames.

7. A display apparatus comprising:
a light unit which comprises a plurality of light sources providing different colors;
a light source driver which turns on the plurality of light sources of the light unit in a given order;
a display unit which outputs an image according to an input image signal;
a processor which divides a frame of the input image signal into a plurality of sub-frames, provides the plurality of sub-frames to the display unit to sequentially output the plurality of sub-frames, and outputs a sync signal to the light source driver to turn on the plurality of light sources in each of the plurality of sub-frames in the given order; and
a controller which controls the light source driver, the processor, and the display unit.

8. The display apparatus as claimed in claim 7, wherein the processor comprises:
a sub-frame calculator which divides the frame of the input image signal into “n” frames, where “n” is an integer greater than or equal to 2;
a display processor which sequentially outputs the “n” sub-frames on a display panel; and
a sync signal processor which adjusts an output vertical sync signal and an output horizontal sync signal according to a number of the sub-frames and outputs the adjusted output vertical and horizontal sync signals to the light source driver.

9. The display apparatus as claimed in claim 8, wherein the display processor comprises:
a divider which divides the input image signal into a plurality of color components; and
a data selector which selectively provides data of the input image signal to the display unit according to the plurality of sub-frames divided by the sub-frame calculator,
wherein the sync signal processor increases a frequency of the output vertical sync signal by “n” times a frequency of an input vertical sync signal and reduces a number of output horizontal sync signals to “1/n” times a number of input horizontal sync signals.

10. The display apparatus as claimed in claim 7, wherein the processor comprises:
a sub-frame calculator which divides the frame of the input image signal into an odd line sub-frame indicating odd lines of the frame and an even line sub-frame indicating even lines of the frame;
a display processor which sequentially outputs the odd line sub-frame and the even line sub-frame on a display panel; and
a sync signal processor which adjusts an output vertical sync signal and an output horizontal sync signal and outputs the adjusted output vertical and horizontal sync signals to the light unit so as to turn on the plurality of light sources in the odd line sub-frame in the give order and turn on the plurality of light sources in the even line sub-frame in the given order.

11. The display apparatus as claimed in claim 8, wherein the plurality of light sources comprise R, G, and B light sources, and
wherein if the R, G, and B light sources are sequentially turned on in one sub-frame, the display processor displays black on the display unit before displaying a next sub-frame.

12. The display apparatus as claimed in claim 7, further comprising a compensator which performs a frame compensation with respect to each of the plurality of sub-frames.

13. A display method comprising:
dividing a frame of an input image signal into a plurality of sub-frames;
adjusting an input vertical sync signal and an input horizontal sync signal according to a number of the sub-frames to generate an output vertical sync signal and an output horizontal sync signal; and
sequentially outputting the plurality of sub-frames and turning on a plurality of light sources of a light unit providing different colors in each of the sub-frames in a given order, according to the output vertical sync signal and the output horizontal sync signal.

14. The display method as claimed in claim 13, wherein if the frame of the input image signal is divided into “n” sub-frames, where “n” is an integer greater than or equal to 2, a frequency of the output vertical sync signal is increased by “n” times a frequency of an input vertical sync signal, and a number of output horizontal sync signals is reduced to “1/n” times a number of input horizontal sync signals.

15. The display method as claimed in claim 14, further comprising if the plurality of light sources comprise R, G, and B light sources, and the R, G, and B light sources are sequentially turned on in one sub-frame, displaying black before displaying a next sub-frame.

16. The display method as claimed in claim 13, further comprising performing a frame compensation with respect to each of the plurality of sub-frames.

17. An image signal processing device comprising:
a sub-frame calculator which divides a frame of an input image signal into a plurality of sub-frames;
a display processor which sequentially outputs the plurality of sub-frames on a display panel; and
a light source driver which turns on a plurality of light sources in a given order per each of the sub-frames,
wherein the plurality of light sources provide different colors.
